(19) United States
(12) Patent Application Publication
(10) Pub. No.: US 2023/0126406 A1
(43) Pub. Date: Apr. 27, 2023

(54) DETECTOR FOR LIQUID CHROMATOGRAPH

(71) Applicant: SHIMADZU CORPORATION, Kyoto (JP)

(72) Inventors: Yuki IIJIMA, Kyoto (JP); Kodai IMAEDA, Kyoto (JP)

(21) Appl. No.: 17/968,973

(22) Filed: Oct. 19, 2022

(30) Foreign Application Priority Data
Oct. 26, 2021 (JP) 2021-175025

(51) Int. Cl. G01N 30/34; G01N 30/74

(52) U.S. Cl. CPC G01N 30/34; G01N 30/74; G01N 2030/8854

(57) ABSTRACT

A detector (50) for a liquid chromatograph includes a tube (56) and a flow cell (52) arranged so that a mobile phase and a sample exiting from a column (10) in a liquid chromatograph (100) flow through the tube into the flow cell which is configured to allow for detection of a component in a sample flowing within the flow cell. The tube includes a first wetted member (56) made of a PEEK resin material. The flow cell has a passage surface formed by a second wetted member (521) including a non-metallic material having a lower electric resistivity than the first wetted member. The use of those wetted members facilitates the discharging of electric charges from the flow cell while preventing adsorption of sample components to the inner surface of the flow cell.

### TECHNICAL FIELD

The present invention relates to a detector for a liquid chromatograph.

### BACKGROUND ART

In a normal type of detector used for liquid chromatography, a metallic material which is highly resistant to corrosion and chemicals, such as stainless steel, is often used as the material for a tube or flow cell through which the mobile phase and the sample eluted from a separation column in a liquid chromatograph flow. However, many samples which are subjected to liquid chromatography in biology, medicine, pharmacy or similar areas easily adsorb to stainless steel or other metallic materials. Accordingly, a detector has been provided in which the portions that will come in contact with the mobile phase and the sample inside the tube or flow cell (those portions are hereinafter called “wetted members”) are made of a non-metallic material.

PEEK (polyether ether ketone) resin is one of the non-metallic materials used for wetted members (Patent Literature 1). PEEK resin is characterized by its excellent resistance to corrosion and chemicals as well as its high mechanical strength as compared to commonly used resin materials. A problem with the resin materials as compared to metal is that they generally have extremely high electric resistance, which is approximately 10¹⁵ Ω·m.

It has been commonly known that, when a liquid flows through a tube at high speeds, static electricity occurs due to the friction between the inner surface of the tube and the liquid, causing the inner surface of the tube to be electrically charged, a phenomenon called “flow electrification”. In the case where the tube is made of stainless steel having low electric resistance, when the inner surface of the tube is electrically charged due to flow electrification, the electric charges are promptly discharged to the outside of the tube. By comparison, when the wetted member of the tube is made of a PEEK resin material having high electric resistance, it is difficult for those electric charges to be discharged to the outside of the tube, so that electric charges are accumulated on the inner surface of the tube, a portion of which flows into the flow cell along with the liquid flowing through the tube.

### CITATION LIST

### Patent Literature

Patent Literature 1: JP 2010-066158 A

### SUMMARY OF INVENTION

### Technical Problem

An ultraviolet-visible spectrophotometer in which a sample component within a flow cell is detected by passing ultraviolet or visible light through the flow cell and measuring absorbance may be used as a detector for a liquid chromatograph. In that case, the light-receiving element is placed in the vicinity of the flow cell so as to accurately detect the amount of light passing through the flow cell. Placing the light-receiving element close to the flow cell causes the problem that a noise component caused by the electric charges which have flown into the flow cell (which may be called the “electrostatic noise”) influences the output signals of the light-receiving element, causing disturbance in the shape of the chromatogram created from those signals.

The problem to be solved by the present invention is to facilitate the discharging of electric charges from the flow cell while using a flow cell including a wetted member made of a non-metallic material.

### Solution to Problem

The present invention developed for solving the previously described problem is a detector for a liquid chromatograph, the detector including a tube and a flow cell arranged so that a mobile phase and a sample exiting from a column in a liquid chromatograph flow through the tube into the flow cell which is configured to allow for detection of a component in a sample flowing within the flow cell, where:

the tube includes a first wetted member made of a PEEK resin material; and

the flow cell has a passage surface formed by a second wetted member including a non-metallic material having a lower electric resistivity than the first wetted member.

### Advantageous Effects of Invention

In the detector for a liquid chromatograph according to the present invention, even in the case of analyzing a sample by liquid chromatography in the area of biology, medicine or pharmacy, the components in the sample flowing through the tube and the flow cell along with the mobile phase can be prevented from adsorbing to the inner surface of the wetted members in the tube and the flow cell. Even when flow electrification occurs within the tube due to the sample flowing through the tube along with the mobile phase, causing the resulting electric charges to flow into the flow cell, the electric charges which have entered the flow cell can be easily discharged by grounding the wetted member in the flow cell since this wetted member has a low electric resistivity.

### BRIEF DESCRIPTION OF DRAWINGS

FIG. 1 is a schematic configuration diagram of a liquid chromatograph including a detector for a liquid chromatograph as one embodiment of the present invention.

FIG. 2 is a schematic configuration diagram of the detector for a liquid chromatograph.

FIG. 3 is a chromatogram showing an example of the result of a measurement performed on the same sample using the detector for a liquid chromatograph according to the present embodiment and a conventional detector for a liquid chromatograph.

### DESCRIPTION OF EMBODIMENTS

One embodiment of the present invention is hereinafter described referring to the drawings.

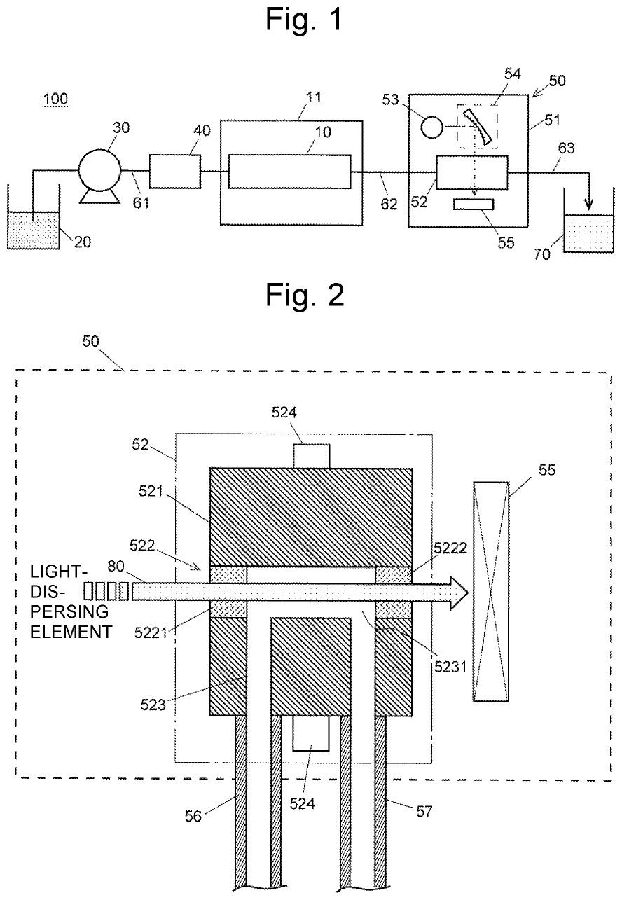

FIG. 1 is a schematic configuration diagram of a liquid chromatograph apparatus including the detector for a liquid chromatograph (which is hereinafter called the “detector”) according to the present embodiment.

The liquid chromatograph apparatus 100 includes a component-separation column 10 contained in a column oven 11, a liquid supply pump 30 configured to suction a mobile phase from a mobile phase container 20 and supply it to the column 10, an injector 40 configured to inject a sample into the mobile phase being sent to the column 10 by the liquid-supply pump 30, a detector 50 configured to detect a component in an eluate coming from the exit port of the column 10, as well as tubes 61 and 62 connecting the liquid-supply pump 30 and the entrance end of the column 10 as well as the exit end of the column 10 and the detector 50, respectively. The liquid which has passed through the detector 50 is discharged through a tube 63 into a drain container 70 as waste liquid.

For example, the detector 50 is an ultraviolet-visible spectrophotometer, which includes a casing 51, a flow cell 52 contained in the casing 51, a light source 53 configured to emit visible or ultraviolet light, a light-dispersing element 54 configured to disperse a beam of light from the light source 53 into a spectrum and cast it into the flow cell 52, and a detection element 55 configured to detect light passing through the flow cell 52.

FIG. 2 is a schematic configuration diagram of the flow cell 52. The flow cell 52 has a cubic cell housing 521 made of a PEEK resin material containing carbon fibers (this material is hereinafter called the “carbon-containing PEEK resin material”), a light passage 522 formed within and penetrating through the cell housing 521, a flow passage 523 through which an eluate coming from the column 10 through the tube 62 flows, and metallic cell holders 524 provided in the upper and lower portions of the cell housing 521 for fixing the same housing 521 to the casing 51. Since the casing 51 is grounded, the cell housing 521 fixed to the casing 51 via the metallic cell holders 524 is also grounded.

The flow passage 523 is a cavity extending in a U-shaped form inside the cell housing 521, with both end portions located on the same side (in FIG. 2, the lower side) of the cell housing 521. The two tubes 56 and 57 are connected to the two ends of the flow passage 523, respectively. The tube 56 is to be connected to the tube 62, while the tube 57 is to be connected to the tube 63. Both tubes 56 and 57 are made of a PEEK resin material. In the present embodiment, the carbon-containing PEEK resin material used as the material of the cell housing 521 has a lower electric-resistance value than the PEEK resin material used as the material of the tubes 56 and 57. The tubes 56 and 57 correspond to the first wetted member, while the cell housing 521 corresponds to the second wetted member.

The flow passage 523 has an intermediate section 5231 extending linearly. It also has a side section extending from one end of the intermediate section 5231 to the end to be connected to the tube 62, and another side section extending from the other end of the intermediate section 5231 to the end to be connected to the tube 63. Both side sections extend in a perpendicular direction to the intermediate section 5231.

In the cell housing 521, a cavity having the same cross-sectional shape as the intermediate section 5231 of the flow passage 523 is formed in the portion from one end of the intermediate section 5231 to one end face of the cell housing 521 as well as in the portion from the other end of the intermediate section 5231 to the opposite end face of the cell housing 521. Light passage members 5221 and 5222 made of glass are fitted in these two cavities, respectively. The light passage member 5221, intermediate section 5231 and light passage member 5222 are arranged in a straight line. The light passage 522 is formed by the light passage member 5221, intermediate section 5231 and light passage member 5222. That is to say, the light passage 522 partially overlaps the intermediate section 5231 of the flow passage 523.

Relative to the flow cell 52 configured in the previously described manner, the light source 53 and the light-dispersing element 54 are arranged so that the light coming from the light-dispersing element 54 enters the light passage member 5221 and directly travels through the light passage 522 to ultimately exit from the light passage member 5222, as indicated by the arrow 80 in FIG. 2. The detection element 55 is located in the vicinity of the light passage member 5222 so as to receive the light exiting from the light passage member 5222.

The eluate coming from the column 10 through the tube 62 passes through the tube 56 and flows within the flow passage 523, to be discharged through the tubes 57 and 63 into the drain container 70. Meanwhile, the light coming from the light-dispersing element 54 and entering the light passage member 5221 travels through the intermediate section 5231 of the flow passage 523 and exits from the light passage member 5222. Therefore, the intensity of the light falling onto the detection element 55 depends on the absorbance of the eluate flowing through the intermediate section 5231.

In the present embodiment, since both the material of the cell housing 521 and that of the tubes 56 and 57 are PEEK resin materials, the components in the sample contained in the eluate can be prevented from adsorbing to the inner surface of the flow passage 523 as well as those of the tubes 56 and 57. Additionally, since the carbon-containing PEEK resin material forming the cell housing 521 has a lower electric resistance than the PEEK resin material forming the tubes 56 and 57, the electric charges which may result from the flow electrification within the tube 56 due to the flow of the eluate through the tube 56 and enter the flow passage 523 can be discharged via the cell housing 521 and the cell holders 524 to the outside. Accordingly, the influence of the electrostatic noise on the detection element, which has been a conventional problem, can be reduced.

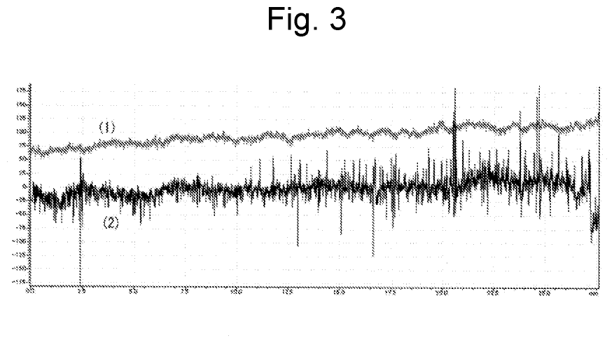

FIG. 3 shows an example of the chromatogram obtained by using the liquid chromatograph apparatus 100 according to the present embodiment in which only acetonitrile as the mobile phase was passed through the column. Graph (1) in FIG. 3 is a chromatogram obtained by using a cell housing 521 made of a carbon-containing PEEK resin material having an electric resistivity of approximately 10³-10⁵ Ω·m, while graph (2) is a chromatogram obtained by using a cell housing 521 made of a PEEK resin material having an electric resistivity of approximately 10¹⁵ Ω·m. FIG. 3 demonstrates that the use of a cell housing having a lower electric resistivity decreases the noise component and reduces the disturbance of the chromatogram.

The cell housing 521 in the previous embodiment is entirely made of a carbon-containing PEEK resin material. However, the minimum requirement is that the portion which corresponds to the wetted member, i.e., the portion which forms the inner circumferential surface of the flow passage and is also in contact with the cell holders, is made of a carbon-containing PEEK resin material. The cell housing 521 may be connected to the casing or the ground by a grounding line without using the cell holders. The use of a PEEK resin material for both of the tubes 56 and 57 is not always necessary; it is possible to have only the tube 56 made of a PEEK resin material. Furthermore, the minimum requirement is that the portion which corresponds to the wetted member, i.e., the portion which forms the inner circumferential surface of the tube 56 is made of a PEEK resin material.

The previous embodiment and its variations are mere examples of the present invention. It is evident that any modification, change or addition which is appropriately made within the gist of the present invention, other than those already described, will also be included within the scope of claims of the present application.

[Various Modes]

A person skilled in the art can understand that the previously described illustrative embodiment is a specific example of the following modes of the present invention.

(Clause 1) The present invention is a detector for a liquid chromatograph, the detector including a tube and a flow cell arranged so that a mobile phase and a sample exiting from a column in a liquid chromatograph flow through the tube into the flow cell which is configured to allow for detection of a component in a sample flowing within the flow cell, where:

the tube includes a first wetted member made of a PEEK resin material; and

the flow cell has a passage surface formed by a second wetted member including a non-metallic material having a lower electric resistivity than the first wetted member.

In the detector for a liquid chromatograph according to Clause 1, even in the case of analyzing a sample by liquid chromatography in the area of biology, medicine or pharmacy, the components in the sample flowing through the tube and the flow cell along with the mobile phase will not adsorb to the inner surface of the wetted members in the tube and the flow cell. Even when flow electrification occurs within the tube due to the sample flowing through the tube along with the mobile phase, causing the resulting electric charges to flow into the flow cell, the electric charges which have entered the flow cell can be easily discharged by grounding the wetted member in the flow cell since this wetted member has a low electric resistivity.

(Clause 2) The detector for a liquid chromatograph according to Clause 1 may include an ultraviolet-visible spectrophotometer configured to cast visible light or ultraviolet light into the flow cell and measure absorbance.

Ultraviolet-visible spectrophotometers measure absorbance by detecting the intensity of visible or ultraviolet light which has been cast into and passed through the flow cell, using a predetermined type of light-receiving element. In order to accurately measure the intensity of the visible or ultraviolet light which has passed through the flow cell, the light-receiving element in the ultraviolet-visible spectrophotometer is normally placed in the vicinity of the flow cell. Therefore, if electric charges are accumulated within the flow cell, those electric charges produce a noise effect on the light-receiving element and prevents the same device from correctly measuring the intensity of the visible or ultraviolet light. The detector for a liquid chromatograph according to Clause 2 can eliminate the noise due to the electric charges since it can discharge the electric charges which have entered the flow cell.

(Clause 3) In the detector for a liquid chromatograph according to Clause 1 or 2, the non-metallic material may be a PEEK resin material containing carbon fibers.

The electric-resistance value of conventionally and commonly used PEEK resin is approximately 10¹⁵ Ω·m. By comparison, the electric-resistance value of PEEK resin containing carbon fibers depends on the content of the carbon fibers. Commercially available products of this type of resin typically have electric-resistance values roughly equal to or lower than 10⁸ Ω·m. PEEK resin containing carbon fibers (which is hereinafter called the “carbon-containing PEEK resin material”) has a similar nature to conventional PEEK resin in that it is highly resistant to chemicals and has a high level of mechanical strength. Therefore, by creating a flow cell using a wetted member made of a carbon-containing PEEK resin material, a flow cell which allows for easy discharging of electric charges while exhibiting high resistance to chemicals and high mechanical strength can be obtained.

The PEEK resin material for the wetted member of the tube (first wetted member) may also contain carbon fibers as long as it has a higher electric-resistance value than the second wetted member of the flow cell.

(Clause 4) In the detector for a liquid chromatograph according to Clause 3, the non-metallic material may be a PEEK resin material containing carbon fibers and having an electric-resistance value equal to or lower than 10⁵ Ω·m.

By creating the second wetted member from a PEEK resin material containing carbon fibers and having an electric-resistance value equal to or lower than 10⁵ Ω·m, it will be easier to discharge electric charges from the flow cell.

(Clause 5) In the detector for a liquid chromatograph according to Clause 3 or 4, the non-metallic material may be a PEEK resin material containing carbon fibers and having a carbon-fiber content equal to or lower than 10%.

By using, as the material of the second wetted member, a PEEK resin material containing carbon fibers and having a carbon-fiber content equal to or lower than 10%, a second wetted member having a low electric resistivity can be realized while suppressing adsorption of the components in the sample to the second wetted member.

(Clause 6) In the detector for a liquid chromatograph according to one of Clauses 1-5, the passage surface may be entirely formed by the second wetted member made of the non-metallic material.

In the detector for a liquid chromatograph according to Clause 6, the electric charges which have entered the flow cell can be efficiently discharged to the outside through the second wetted member which forms the entirety of the passage surface.

(Clause 7) The detector for a liquid chromatograph according to one of Clauses 1-6 may further include:

a casing; and

a cell holder made of metal and being in contact with the second wetted member, where the cell holder is in contact with the casing.

In the detector for a liquid chromatograph according to Clause 7, the electric charges which have entered the flow cell can be discharged through the second wetted member and the cell holder to the casing.

### REFERENCE SIGNS LIST

10 . . . Column
100 . . . Liquid Chromatograph Apparatus
50 . . . Detector
51 . . . Casing
52 . . . Flow Cell
521 . . . Cell Housing
522 . . . Light Passage
5221, 5222 . . . Light Passage Member
523 . . . Flow Passage
524 . . . Cell Holder
55 . . . Detection Element
56, 57 . . . Tube

1. A detector for a liquid chromatograph, the detector including a tube and a flow cell arranged so that a mobile phase and a sample exiting from a column in a liquid chromatograph flow through the tube into the flow cell which is configured to allow for detection of a component in a sample flowing within the flow cell, wherein:
the tube includes a first wetted member made of a PEEK resin material; and
the flow cell has a passage surface formed by a second wetted member including a non-metallic material having a lower electric resistivity than the first wetted member.

2. The detector for a liquid chromatograph according to claim 1, comprising an ultraviolet-visible spectrophotometer configured to cast visible light or ultraviolet light into the flow cell and measure absorbance.

3. The detector for a liquid chromatograph according to claim 1, wherein the non-metallic material is a PEEK resin material containing carbon fibers.

4. The detector for a liquid chromatograph according to claim 3, wherein the non-metallic material is a PEEK resin material containing carbon fibers and having an electric resistance value equal to or lower than 10⁵ Ω·m.

5. The detector for a liquid chromatograph according to claim 3, wherein the non-metallic material is made of a PEEK resin material containing carbon fibers and having a carbon-fiber content equal to or lower than 10%.

6. The detector for a liquid chromatograph according to claim 1, wherein the passage surface is entirely formed by the second wetted member made of the non-metallic material.

7. The detector for a liquid chromatograph according to claim 1, further comprising:
a casing; and
a cell holder made of metal and being in contact with the second wetted member, wherein the cell holder is in contact with the casing.
